(19) United States
(12) Patent Application Publication
(10) Pub. No.: US 2012/0138449 A1
(43) Pub. Date: Jun. 7, 2012

(54) METHOD OF REMOVING SULFUR FROM CRUDE OIL AND DIESEL USING IONIZING RADIATION

(75) Inventors: Ahmed Ali Basfar, RIYADH (SA); Khaled Abdel-Aziz Mohamed, Cairo (EG)

(73) Assignee: King Abdulaziz City for Science and Technology (KACST), Riyadh (SA)

(21) Appl. No.: 13/371,467

(22) Filed: Feb. 12, 2012

(51) Int. Cl. C07B 63/00

(52) U.S. Cl. 204/158.21

(57) ABSTRACT

The present disclosure relates to a method and process to remove the remaining sulfur in four types of Arabian crude oils (Arabian Heavy) (AH) and straight-run diesel (SRD) by ionizing radiation. Radiation-induced desulfurization is not feasible for absorbed doses up to 200 kGy. Most of the organically bound sulfur and/or elemental sulfur and hydrogen sulfide still exist in the irradiated samples. Sulfur removal from crude oil and straight-run diesel was achieved by combining gamma-irradiation with other physical/chemical processes (i.e. liquid/liquid extraction and oxidation) which provided a considerable levels of total sulfur reduction in the investigated products (AH and SRD). The best removal processes for Arabian heavy crude oil and straight-run diesel resulted in reducing total sulfur content up to 36% (AH) and 78% (SRD) corresponding to (liquid process/200 kGy) and (liquid process/200 kGy) for AH and SRD, respectively.

### FIELD OF THE INVENTION

The present disclosure relates to a method of removing sulfur from crude oil and diesel by ionizing radiation.

### BACKGROUND

Recent developments in environmental legislations are inexorably moving us to a world of zero-sulfur emission standards. Global warming is demanding that this problem be addressed and be addressed soon. In the wake of these legislations, especially in the case of gasoline desulphurization, quite a number of novel processes such as catalytic and non-catalytic ones options have been revisited (Brunet S et al. 2005).

Sulfur-containing compounds that are typically present in hydrocarbon fuels include aliphatic molecules such as sulfides, disulfides, and mercaptans as well as aromatic molecules such as thiophene, benzothiophene, dibenzothiophene, and alkyl derivatives such as 4,6-dimethyl-dibenzothiophene. Those later molecules have a higher boiling point than the aliphatic ones and are consequently more abundant in higher boiling fractions.

Conventional hydro-desulfurization (HDS) technology can desulfurize aliphatic and cyclic sulfur-containing organic compounds on an industrial scale, as in most refineries in the world. Aromatic dibenzothiophene (DBT) and especially 4,6-alkyl-substituted DBTs, however, are difficult to convert to H₂S due to the sterically hindered nature of these compounds on the catalyst surface (Shiraishi Y et al. 2002).

For this reason, removal of the DBTs by HDS to give the desired low levels of sulfur requires high temperature and H₂ pressure conditions and hence a larger reactor as well as an active catalyst is required. From environmental and economic viewpoints, it is desirable to develop a more energy-efficient desulfurization process for production of virtually sulfur-free fuel.

Deep desulfurization processes include selective adsorption, (McKinley S, Angelici R 2003), extraction with ionic liquids (Bosmann L. et al. 2001), oxidative desulfurization (ODS) (Garcia-Gutierrez J et al. 2006) and other processes (Song C et al. 2003). Due to a short reaction time at ambient conditions, high efficiency, and selectivity, ODS combined with extraction is among the most promising processes. In this process, such sulfur-containing species as sulfides, benzothiophene, dibenzothiophene, and alkyl-related derivatives are transformed into the corresponding sulfoxides or sulfones species, which are then removed in a second step.

An extractive distillation process, GT-DeSulph™, has been reported by GTC in 2002. The GT-DeSulph™ utilizes a proprietary aromatics selective solvent, which is effective in extracting thiophenic sulfur species and aromatics, and to a limited extent, mercaptans and sulfides as well (Kumar S and Gentry J 2003).

Consequently, various studies on the oxidative desulphurization (ODS) process have been employed for different oxidizing agents, such as NO₂ (Tam P et al. 1990) tert-butyl-hydroxide (Wang E et al. 2003) and H₂O₂ (Garcia-Gutierrez J et al. 2006). Hydrogen peroxide is commonly used as an oxidizing reagent due to its relatively low price, environmental compatibility, and commercial availability.

H₂O₂ is effective in the presence a transition-metal based catalyst and in acidic media. Examples of transition-metal-based systems are tungstophosphoric acid (Yazu K et al. 2004) and other transition metal-based oxides (Yu B et al 2006). Some catalytic system was evaluated for the removal of sulfur-containing compounds in diesel (Xiao T et al. 2008).

A combined oxidation and extraction desulfurization process is described by Li C et al. (2004). The catalyst [(C₁₈H₃₇)2N⁺(CH₃)₂]₃[PW₁₂O₄₀] assembled in emulsion droplets can selectively oxidize the sulfur-containing molecules present in diesel using H₂O₂ as an oxidant under mild conditions. The catalyst in the emulsion demonstrates high performance (≧96% efficiency of H₂O₂, is easily recycled, and ˜100% selectivity to sulfones) that makes it possible to achieve the ultra-deep desulfurization (<0.1 ppm sulfur).

In addition, the new oxidation system was tested on a commercial diesel sample supplied by Rabigh refinery in Saudi Arabian Oil Company (Saudi Aramco). The sulfur-containing compounds in the diesel sample were oxidized to their corresponding sulfones, and these were further extracted with methanol. The sulfur concentration was successfully reduced by ODS and then by extraction to more than 92% and 97%, respectively (Al-Shahrani F et al. 2009). The chemical and physical properties of sulfones are much different from those of fuel oil hydrocarbons. Therefore, they can be easily removed by conventional separation such as distillation, solvent extraction, adsorption, and decomposition, (Garcia-Gutierrez J et al. 2006, Yu B et al. 2006).

Extraction of organic sulfur compounds from diesel feed by a variety of extractants, from common polar organic solvents to ionic liquids, is discussed in many reports. It appears that a selective extraction of aromatic sulfur compounds from diesel is not straightforward. This comes from the fact that the polarity of such aromatic sulfide type compounds is too close to that of aromatic hydrocarbon molecules of similar structures without a sulfur atom. The experimental results of liquid extraction of organic solvents indeed demonstrate a poor removal of sulfur compounds from the feed (˜50% at most), and also a high amount of co-extraction of aromatic hydrocarbon molecules, leading to a high loss of feed volume.

The use of a very different type of extractant, namely ionic liquid, is reported by the group of Wasserscheid. An ionic liquid is a non-volatile organic liquid salt, which potentially can extract sulfur and also organic nitrogen compounds in fuels by its polarity. Eber J et al. (2004) gives a good recent overview on the desulfurization with different types of ionic liquids, particularly on the most promising water-stable and less costly (i.e., 1-n-butyl-3 methylimidazolium octylsulfate) type. Given the poor extraction of alkylthiols and sulfides, the formation of liquid-clathrates and p-p interaction is assumed to be the main driving force for extraction.

Interestingly, it is reported that the extraction of 4-methyl DBT and 4,6-dimethyl DBT proceed almost as efficiently as that of DBT. Furthermore, nitrogen compounds are found to be more efficiently extracted than sulfur compounds. The problems of the ionic liquid process are the limited extraction efficiency of sulfur compounds, cross-solubility of hydrocarbons and the regeneration of expensive ionic liquid compounds. With respect to the extraction efficiency, they have, for instance, proposed a 10 steps extraction to reduce sulfur content of 300 towards <10 ppmw (Jess A et al. 2003). Zaykina R. et al. discussed the use of radiation method for demercaptanization and/or desulfurization of oil products (Crude and Fuel oils) in 2002. It was proposed that improved desulfurization involves two stages: radiation pre-processing, followed by the standard procedure for extraction of deeply oxidized sulfuric compounds. During the first stage, no desulfurization of the overall product is observed. It results in strong oxidation of sulfur species reducing their chemical aggressiveness and enhancing their removal potential in stage 2. In addition, it causes moderate sulfur redistribution in the overall product leading to partial desulfurization of light fractions. The high level of sulfur oxidation is proposed to be a result of the double activation of oxidation processes by both radiation activation of the feedstock and activation from atmospheric air. The ozone-containing air, excited by energetic electron bombardment, appears to play the role of an oxidizer. In this disclosure, no experimental details were discussed. Accordingly, the reliability of this work is questionable.

An efficient and highly practical novel desulfurization device capable of executing the depth desulfurization was reported by Ayukawa Y., Ono M. (2003). A high-energy beam irradiating desulfurization device for a petroleum product or a petroleum semi-manufactured product, comprising a catalyst liquid-liquid contact part for contacting a metal compound solution as a catalyst and the petroleum product or the petroleum semi-manufactured product, a high-energy beam irradiating part, and a sulfide collecting part for separating and collecting sulfide of the metal produced by the high-energy beam irradiation, is provided.

A process for desulfurizing a petroleum oil containing sulfur comprises subjecting the oil to high-energy ionizing radiation from an atomic pile whereby a substantial proportion of the sulfur is converted to a less stable form and then contacting the liquid oil product with an adsorbent or solvent which selectively removes the less stable sulfur. A detailed method was followed to desulfurize the oil and about 50% conversion (cracking plus polymerization) took place with each oil (Esso Research, Engineering Company, 1960). There is a need for alternative green technology based approaches over the conventional desulfurization of crude oil and diesel.

### SUMMARY

The disclosure describes a method and a process of desulfurizing crude oil and diesel. More particularly it describes desulpurization of Arabian heavy crude oil (AH) and straight run diesel (SRD) using irradiation.

In one embodiment, a sulfur compound present in the AH and SRD is chemically modified to obtain a chemically active AH and SRD for irradiation. In one embodiment, a method to remove sulfur during extraction is to first oxidize sulfur compounds in AH and SRD by adding oxidants prior to extraction and/or irradiation. In another embodiment, after oxidization of the sulfur compounds present in AH and SRD an extraction method using solvents may be performed prior to irradiation. This oxidation/extraction method is performed to increase the polarity of the sulfur compounds present in the AH and SRD, which increases the partition coefficient of the sulfur molecules in the solvent. In another embodiment a cocktail of solvents i.e. a combination of various solvents may be used for extraction prior to irradiation.

In another embodiment, the chemically active AH and SRD are irratiated using a specific absorbed dose. The specific absorbed dose may be between 50-200 kGy. In another embodiment, a process or a method for removing total sulfur in Arabian heavy (AH) crude oils (≅3 mass %) and straight-run diesel (SRD)(≅1.41 mass %) by ionizing radiation is performed. In another embodiment, AH and SRD are exposed to absorbed doses from 50 to 200 kGy to remove the sulfur.

According to another embodiment, the removal of total sulfur is done in the presence of oxidizer (H₂O₂ and H₂O₂/CH₃COOH). In another embodiment, the process of Advanced Oxidation Processes AOPs, which involve oxidation of sulfur species by .OH radical and other oxidizing radicals, such as radiolysis by gamma-rays provides novel process to remove and/or decrease the total sulfur content. In an another embodiment, ionizing radiation from electron beam accelerators or gamma ray sources is used as a process for oxidation removal of sulfur compounds.

In addition, in another embodiment, sulfur removal from crude oil (AH and others) and SRD was achieved by combining gamma-irradiation with other physical/chemical processes (i.e. Liquid/Liquid extraction and oxidation) which produced considerable reduction of total sulfur in AH and SRD.

In one embodiment, sulfur reduction level are measured as a result of irradiation of crude oil and straigh-run diesel. In another embodiment, a process of removing sulfur from crude oil (eg. AH) and straigh-run diesel by subjecting them to radiation to improve quality and environmental safety may be considered.

According to one embodiment, crude oil is irradiated and level of total sulfur contents are measured. In another embodiment, straigh-run diesel is irradiated and level of total sulfur contents are measured.

The methods and processes disclosed herein may be implemented in any means for achieving various aspects, and may be executed manually or automated using a computer. Other features will be apparent from the accompanying drawings and from the detailed description that follows.

### BRIEF DESCRIPTION OF FIGURES

FIG. 1 shows a schematic diagram for processing steps used for Arabian heavy crude oil and straight-run diesel.

FIG. 2 shows a schematic diagram for total sulfur content removal (%) in Arabian heavy crude oil (AH) for various irradiation processes.

FIG. 3 shows a total sulfur content removal (%) in Arabian heavy crude oil for various irradiation processes.

FIG. 4 shows a schematic diagram for total sulfur content removal (%) in straight-run diesel (SRD) for various irradiation processes.

FIG. 5 shows a total sulfur content removal (%) in straight-run diesel (SRD) for various irradiation processes.

FIG. 6 shows a process of extraction-oxidation of thiophene and DBT in crude oil/straight-run diesel by aqueous-H₂O₂ system.

Other features of the present embodiments will be apparent from the accompanying drawings and from the detailed description that follows.

### DETAILED DESCRIPTION

The disclosure describes a method and a process to desulfurize crude oil (e.g. AH) and SRD to reduce pollution to restore or maintain the basic life-sustaining natural elements, i.e., air.

### Materials and Method:

Arabian heavy crude oil (AH) with sulfur content of (≅3 mass %) and straight-run diesel (SRD, comes from a mixture of Arabian light and Arabian heavy—65% by volume Arabian light) with sulfur content of (≅1.41 mass %) were received from Saudi Arabian Oil Company (Saudi Aramco). All samples were maintained under laboratory temperature (20-25° C.) prior to experimental work. The properties of these two samples were evaluated.

Organic solvents (analysis grade) for dissolving, extracting and measuring were acetone, acetonitrile, methanol, hexane, heptanes, toluene and petroleum ether and were purchased from Merck (Germany) and Sigma-Aldrich (UK). Hydrogen peroxide, acetic acid, sodium chloride and potassium hydroxide were obtained from Sigma-Aldrich (UK), (Table A).

TABLE A
List of chemicals used in this invention.

| No. | Chemical | Source |
|---|---|---|
| 1 | Acetone | Sigma-Aldrich, UK. |
| 2 | Acetonitrile | Merck, Germany. |
| 3 | Methanol | Sigma, UK. |
| 4 | Hexane | Merck, Germany. |
| 5 | Heptanes | Merck, Germany. |
| 6 | Toluene | Sigma-Aldrich, UK. |
| 13 | Petroleum ether (40-60) | Sigma-Aldrich, UK. |
| 16 | Hydrogen peroxide | Sigma, UK. |
| 17 | Acetic acid | Sigma-Aldrich, UK. |
| 18 | Sodium chloride | Sigma-Aldrich, UK. |
| 19 | Potassium hydroxide | Sigma-Aldrich, UK. |

A Cobalt-60 gamma rays source model Gamma Cell 220 from MDS Nordion, Canada was used for all irradiation studies. The source was calibrated using aqueous ferrous sulfate (Fricke dosimetry) solution according to ASTM Standard Practice E1026, (1997) and dose rate and transit dose were calculated. The typical dose rate was 9828 Gy h⁻¹ and transit dose was estimated to be 12.07 Gy. All of the irradiations were conducted at room temperature, 24-25 C.

The apparatus used to measure the kinematics viscosity is Spectro-Visc Automatic Viscometer (SPECTRO_{INC}. QinetiQ North America, Spectro-Visc Automatic Viscometer Model). The Spectro-Visc is a bench-top semi-automatic kinematic temperature bath viscometer optimized for the analysis of used oil, new lubricants and other fluids. It conforms to the requirements in ASTM D445, D446, D7279, IP 71 and ISO 3104. It is also the ideal system for used oil analysis laboratories that need to test a wide range of lubricant viscosities. The entire cycle time from sample injection to data readout ranges from 4 to 8 minutes per tube when ASTM D445 precision is required. The Kinematics viscosity is the dynamic viscosity divided by the density.

The apparatus used to measure the water content is Coulometer (METTLER TOLEDO Co., USA, KF Coulometer DL39 Model). Coulometric Karl Fischer titration is a useful technique for wide-range water determination, from the percentage level down to trace amounts at the ppm level. The METTLER TOLEDO DL39 coulometer is ideal for water contents in the range 1 ppm to 5%. The DL39 is optimized for simple routine determinations and offers additional possibilities such as statistical functions, a method memory for fifty user methods and more sophisticated calculation functions. The DL39 is also ready-equipped for upgrade to a fully automated system.

The apparatus used to measure the Total Acid Number (TAN) is Titration Excellence (METTLER TOLEDO Co., USA, KF Excellence Titrator T70 Model). Petrochemical products require optimized parameters for reliable end point and equivalence point titrations in non-aqueous media. The Titration Excellence line helps with intelligent application modes, where the titration mode (e.g. acid/base non-aqueous) is selected and the optimal control parameters are automatically set. TAN measurements were carried out in accordance with ASTM D664.

The apparatus used to measure the total sulfur and metals content is Spectroil M Oil and Fuel Analysis Spectrometer (SPECTRO_{INC}. QinetiQ North America, Spectroil M Model). The Spectroil M is an optical emission spectrometer that has been specifically designed for the analysis of sulfur and metals in lubricating oil, hydraulic fluids and coolants. Analysis was carried out in accordance with ASTM D-4057.

Various processes or treatments were performed on Arabian heavy crude oil and straight-run diesel samples. Samples (about 80 ml) are exposed to targeted irradiation doses (50, 100 and 200 kGy) in a Pyrex® vials (100 ml) having airtight caps with teflon-based silicon septa. AH and SRD samples were irradiated in a simple closed system of two vials connected by plastic tube.

L/L Extraction Process: The extraction of the inorganic sulfur compounds and/or other oxidized sulfur compounds (polar compounds such as thiols, sulfides and disulfides) from irradiated samples was conducted to develop a technology for improved removal of total sulfur of irradiated samples. In this respect, the liquid/liquid extraction was conducted using different polar solvents (i.e. sodium chloride aqueous solution, acetonitrile and methanol).

Transfer 40 ml of irradiated Arabian heavy crude oil and/or straight-run diesel samples to a 250 ml separator funnel and add 80 ml (tap water containing 5 ml saturated sodium chloride aqueous solution or acetonitrile or methanol). Shake vigorously for 5 minutes and allow a sufficient length of time which ranged over 1 hour (SRD) to 4 hours (AH) for complete phase separation. In all mentioned extraction processes, drain the aqueous polar layer from the separator funnel and collect targeted non-polar layer (AH and/or SRD) for selected measurements.

The Use of Oxidizer (H₂O₂): Transfer 64 ml of AH and/or SRD samples to a 250 ml separator funnel and add 16 ml H₂O₂ oxidizer (50% concentration) to prepare 10% concentration of H₂O₂ as final concentration in the samples. Shake vigorously for 1 minute and transfer samples (about 80 ml) to a simple closed system of two vials as described in irradiation section. Expose AH and SRD samples to targeted irradiation doses (50, 100 and 200 kGy).

H₂O₂ Oxidizer and Acetic Acid (HAG): Transfer 62.4 ml of AH and/or SRD samples to a 250 ml separator funnel and add 16 ml H₂O₂ oxidizer (H₂O₂ concentration in samples 10%) and 1.6 ml CH₃COOH(CH₃COOH concentration in samples 2%). Then shake vigorously for 1 minute and transfer samples (about 80 ml) to a simple closed system of two vials as described in irradiation section. Then AH and SRD samples are exposed to targeted irradiation doses (50, 100 and 200 kGy).

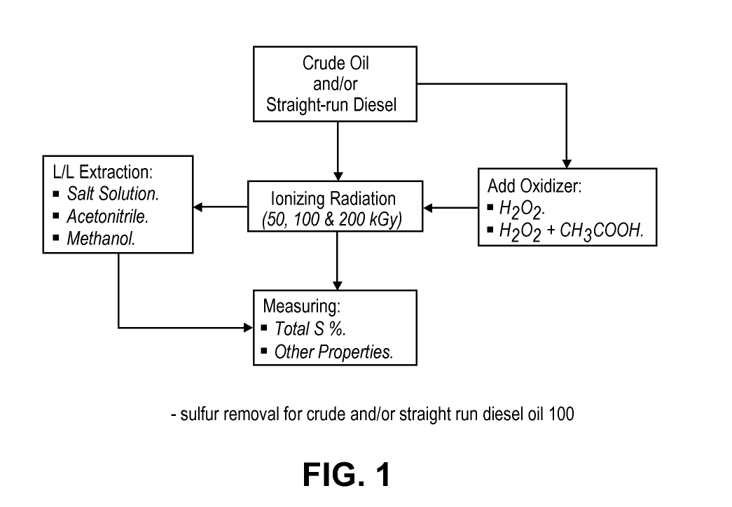

A schematic diagram illustrates the processing steps on crude oil and straight-run diesel samples are shown in FIG. 1.

To facilitate the presentation of the processing steps applied on crude oil and straight-run diesel, each process will be conducted separately as follows:
Irradiation only (A).
Irradiation with extraction (salt solution) (B).
Irradiation with extraction (acetonitrile) (C).
Irradiation with extraction (methanol) (D).
Irradiation with oxidizer [H₂O₂ (10%)] (E).
Irradiation with oxidizer [H₂O₂ (10%)] and extraction (salt solution) (F).
Irradiation with oxidizer [H₂O₂ (10%)] and extraction (acetonitrile) (G).
Irradiation with oxidizer [H₂O₂ (10%)] and extraction (methanol) (H).
Irradiation with oxidizer [H₂O₂ (10%)+CH₃COOH (2%)] (I)
Irradiation with oxidizer [H₂O₂ (10%)+CH₃COOH (2%)] and extraction (salt solution) (J).
Irradiation with oxidizer [H₂O₂ (10%)+CH₃COOH (2%)] and extraction (acetonitrile) (K).
Irradiation with oxidizer [H₂O₂ (10%)+CH₃COOH (2%)] and extraction (methanol) (L).

The characteristics of the irradiated Arabian heavy crude oil (AH) and straight-run diesel (SRD) samples including density, API gravity, dynamic viscosity and kinematics viscosity at 40° C. and total sulfur content (%) were measured for all of the irradiated samples. In addition, sulfur removal (%) from targeted samples was also determined by the difference in sulfur content in un-irradiated and irradiated samples. The total percentage of sulfur (%) was determined at least in triplicates for each sample.

### EXAMPLES

### Example 1

### Influence of Irradiation

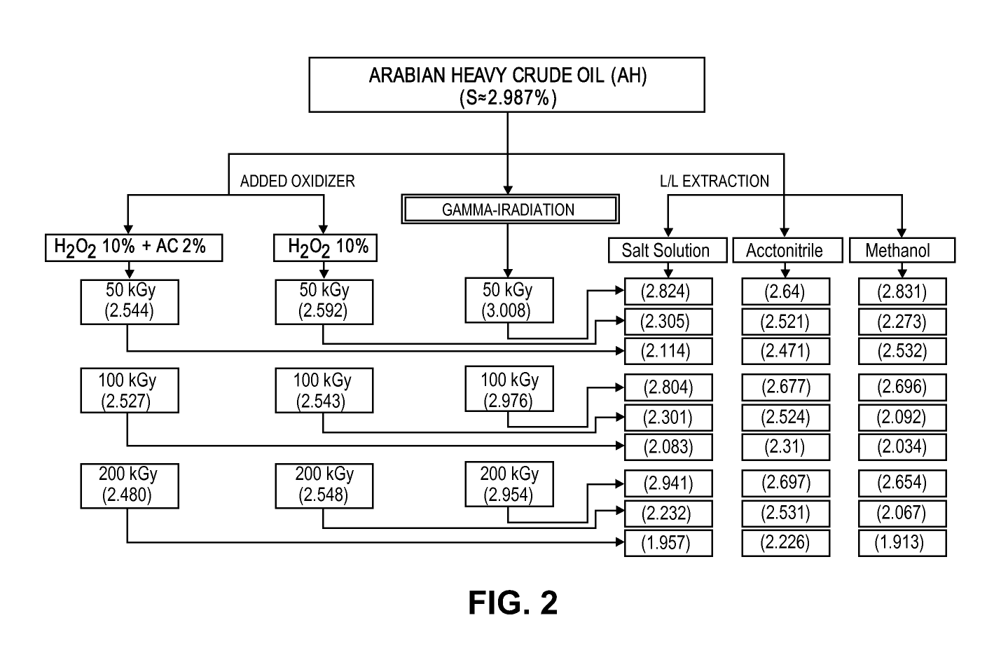

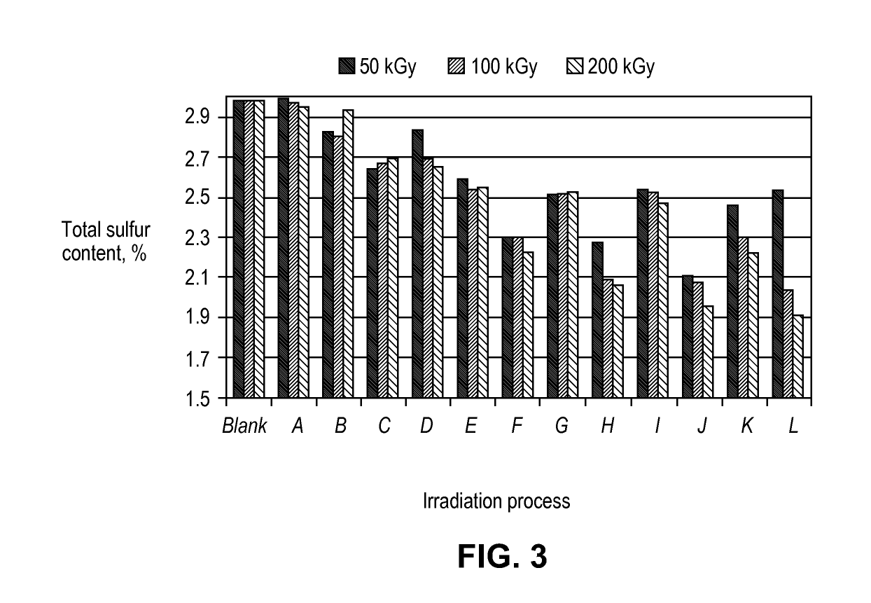

The total sulfur including all of sulfur compounds in the AH which can be oxidized to inorganic sulfur compounds upon irradiation, was measured over various absorbed doses, and the results are shown in Table 1, FIGS. 2 and 3. Results indicate that the total sulfur levels in the AH samples irradiated at absorbed doses up to 200 kGy were difficult to desulfurize to significantly lower sulfur levels. Upon irradiation, the total sulfur content remained almost constant despite the fact that conversion of some organic sulfur compounds (i.e. BT and DBT) is taking place with the increase of absorbed dose. This indicates that the converted inorganic sulfur compounds still exist in the irradiated AH and that the desulfurization of AH by γ-radiation was not efficient.

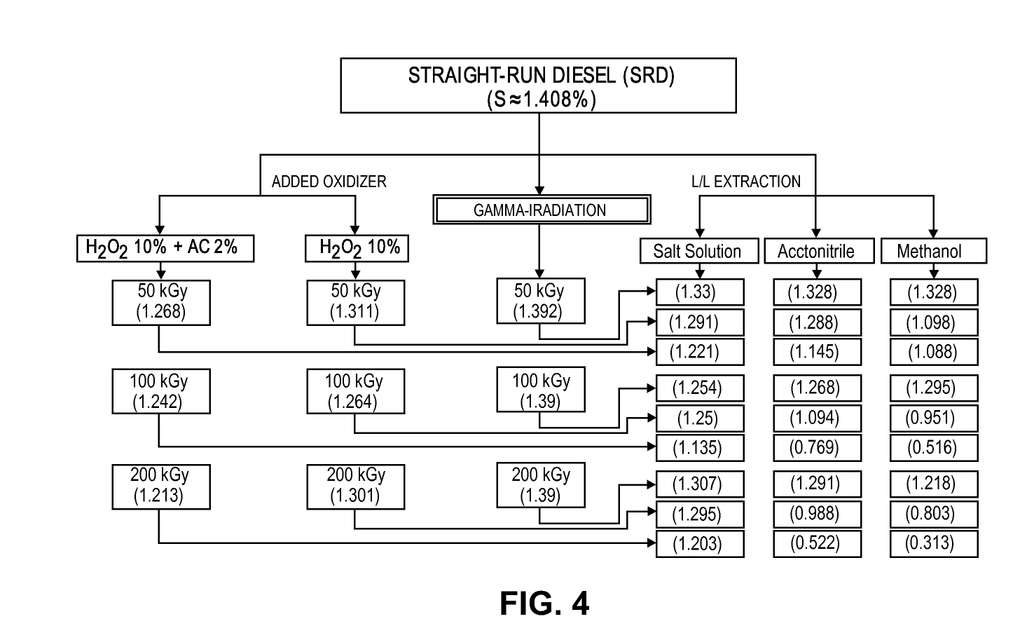

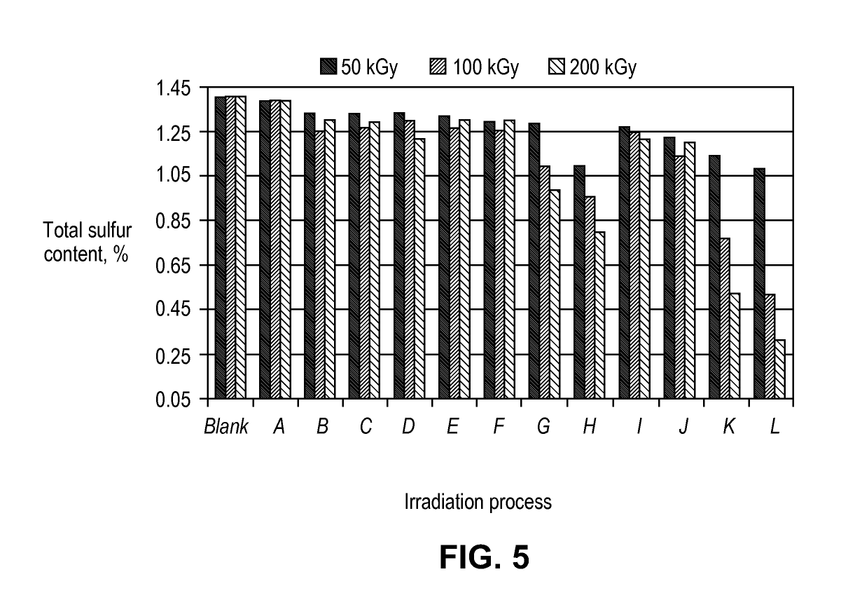

On the other hand, the desulfurization of SRD samples irradiated at absorbed doses up to 200 kGy like Arabian heavy crude oil (AH) was not possible [see Table 2, FIGS. 4 and 5]. The instant results indicated that most of the organically bound sulfur and/or elemental sulfur and hydrogen sulfide still exist in the oil sample after exposure to high irradiation doses.

### Example 2

### Influence of Irradiation with Extraction

Sulfur removal (%) from Arabian heavy crude oil (AH) samples was determined for irradiated samples and irradiated samples with extraction. In this respect, irradiated samples followed by various liquid-liquid extraction processes were also analyzed and the total percentage of sulfur (%) was determined [see Table 1, FIGS. 2 and 3].

The instant results indicated that most of the organically bound sulfur (sulfur occurs in aromatic structures) and/or elemental sulfur and hydrogen sulfide still exist even after exposure to irradiation up to 200 kGy. Subsequently, sulfur removal from irradiated samples can take place by direct extraction of inorganic sulfur (aliphatic sulfur compounds) and other oxidized sulfur compounds (water-soluble compounds such as thiols, sulfides and disulfides) using different polar solvents (i.e. salt solution, acetonitrile and methanol).

In this respect, tap water containing 5 ml saturated sodium chloride solution, acetonitrile and methanol were used for extraction of oxidized sulfur compounds. The result was a reduction in the sulfur content from an initial level of 2.987 by weight to final levels of 2.824, 2.804 and 2.941% (salt solution); 2.640, 2.677 and 2.697% (acetonitrile) and 2.831, 2.696 and 2.654% (methanol) with absorbed doses of 50, 100 and 200 kGy, respectively. The corresponding sulfur removal percentages (%) reached values of 7.83, 8.49 and 4.01; 11.62, 10.38 and 9.71 and 5.22, 9.74 and 11.15 for the investigated solvents and absorbed doses, respectively. From instant results, it is observed that absorbed doses of 50 and 100 kGy with acetonitrile extraction showed slightly higher efficiency for sulfur removal process compared with salt solution and methanol.

Therefore, the combination of irradiation and L/L extraction process is incapable of removing considerable levels of sulfur compounds in the Arabian heavy crude oil. It is interesting to notice that, the efficiency of desulfurization by extraction is mainly limited by the solubility of the organic sulfur compounds in the selected solvent. Solubility can be enhanced by choosing an appropriate solvent taking into account the nature of the sulfur compounds to be removed. For this reason, solvents of different nature can be tested including acetone, ethanol, polyethylene glycols, nitrogen containing solvents and by preparing a ‘solvent cocktail’ such as acetone—ethanol or a tetraethylene glycol—methoxy tri-glycol mixture.

On the other hand, sulfur removal from SRD can take place by extraction of inorganic sulfur (aliphatic sulfur compounds) and other oxidized sulfur compounds (water-soluble compounds such as thiols, sulfides and disulfides) using different polar solvents. In this respect, salt aqueous solution, acetonitrile and methanol were used for extraction of oxidized sulfur compounds. The result was a reduction in the sulfur content from an initial level of 1.408 by weight to final levels of 1.33, 1.254 and 1.307% (salt solution); 1.328, 1.268 and 1.291% (acetonitrile) and 1.328, 1.295 and 1.218% (methanol) with absorbed doses of 50, 100 and 200 kGy, respectively. The corresponding sulfur removal percentages (%) reached values of 5.54, 10.94 and 7.17%; 5.68, 9.94 and 8.31% and 5.68, 8.03 and 13.49% for the same solvents and absorbed doses, respectively. From instant results, it can be reported that the three investigated solvents showed the same trend in sulfur removal percentages (5.5-11%). In addition, an absorbed dose of 100 kGy showed more efficiency for extraction process compared with 50 and 200 kGy taking into account the economic aspects [see Table 2, FIGS. 4 and 5].

### Example 3

### Influence of Irradiation with Oxidizer

The effect of H₂O₂ was investigated as follows: The aqueous solution of H₂O₂ was mixed with the AH samples (about 10 wt %) by shaking and the results are shown in Table 1, FIGS. 2 and 3. It was shown previously that H₂O₂ can slightly improve the removal of total sulfur content under γ-radiation. When H₂O₂ was introduced into the reaction, the total sulfur in the AH decreased slightly along with organic sulfur compounds conversions during irradiation, which means that almost some of the converted inorganic sulfur was transferred from the oil phase to the water phase. The result showed that, the total sulfur removal percentages reached values of 13.22, 14.86 and 14.70% with the absorbed doses of 50, 100 and 200 kGy, respectively. Therefore, this combination of irradiation and H₂O₂ is not an efficient method for total sulfur removal.

In addition, the effect of H₂O₂ at concentration of 10 wt % with irradiation on the reduction of sulfur contents was investigated with the SRD and the results are shown in Table 2, FIGS. 4 and 5. Results indicated that addition of H₂O₂ to SRD improved slightly the removal of sulfur under γ-radiation. The results showed that, the total sulfur removal percentages reached values of 6.89, 10.23 and 7.60% with the absorbed doses of 50, 100 and 200 kGy, respectively. It is interesting to notice that when H₂O₂ was introduced into the reaction, the total sulfur in the SRD phase slightly decreased along with organic sulfur compounds conversions in the SRD phase during irradiation. This means that slight concentration of the converted inorganic sulfur was transferred from the SRD phase to the H₂O₂/water phase. In this respect, the fast separation between two phases (5 minutes) during irradiation played an important role in hindering complete conversion process to inorganic sulfur. Therefore, this combination of irradiation and H₂O₂ is not an efficient method for total sulfur removal.

### Example 4

### Influence of Irradiation with Oxidizer and Extraction

When H₂O₂ was added and followed by extraction processes, a significant improvement was observed in the removal of total sulfur content upon irradiation at room temperature. As shown in Table 1, FIGS. 2 and 3, when the volume ratio of oil/H₂O₂ was 4:1 and the initial concentration of total sulfur was 2.987%, about 22.83, 22.97 and 25.28% (salt solution extraction); 15.60, 15.51 and 15.27% (acetonitrile extraction) and 23.90, 29.96 and 30.80% (methanol extraction) of total sulfur contents was removed from Arabian heavy crude oil with absorbed doses of 50, 100 and 200 kGy, respectively. Moreover, about 23.7, 15.5 and 28.2% of total sulfur on the average was removed from AH with absorbed doses up to 200 kGy for the three investigated extraction processes, respectively.

On the other hand, upon the addition of H₂O₂ (10 wt %) to SRD samples followed by irradiation and extraction processes, a significant improvement was observed in the reduction of total sulfur contents [see Table 2, FIGS. 4 and 5]. About 8.31, 11.22 and 8.03% (salt solution extraction); 8.52, 22.30 and 29.83% (acetonitrile extraction) and 22.02, 32.46 and 42.97% (methanol extraction) of total sulfur contents was removed from the initial concentration of SRD (1.408%) with absorbed doses of 50, 100 and 200 kGy, respectively. Moreover, about 9.2, 20.2 and 32.48% on the average of total sulfur contents was removed from SRD with absorbed doses up to 200 kGy for three investigated extraction processes, respectively.

### Example 5

### Influence of Irradiation with Oxidizer/Acetic Acid (AC) and Extraction

By adding H₂O₂ with acetic acid (AC) to AH, followed by extraction processes, a significant improvement was observed in the removal of total sulfur contents upon irradiation at room temperature. As shown in Table 1, FIGS. 2 and 3, when the volume ratio of Oil/H₂O₂/AC was 39:10:1 and the initial concentration of total sulfur contents was 2.987%, about 29% of total sulfur was removed from Arabian heavy crude oil at an absorbed dose of 50 kGy. Similarly, about 34 and 36% of total sulfur was removed from AH with absorbed doses of 100 and 200 kGy, respectively. In this respect, about 29.23, 30.26 and 34.48% (salt solution extraction); 17.27, 22.66 and 25.48% (acetonitrile extraction) and 15.23, 31.90 and 35.96% (methanol extraction) of total sulfur was removed from the AH with absorbed doses of 50, 100 and 200 kGy, respectively. The results indicated that the combination of H₂O₂/AC/γ-radiation and followed by extraction improved removal efficiency of total sulfur.

TABLE 1

| | | Absorbed dose (kGy) | | | |
|---|---|---|---|---|---|
| No. | Process | 0 | 50 | 100 | 200 |
| 1 | Irradiation only (A). | 2.987 ± 0.09 | 3.008 ± 0.08 | 2.976 ± 0.02 | 2.954 ± 0.01 |
| | | | (*) | (*) | (*) |
| 2 | Irradiation with extraction (salt solution) (B). | | 2.824 ± 0.03 | 2.804 ± 0.04 | 2.941 ± 0.07 |
| | | | (7.83) | (8.49) | (4.01) |
| 3 | Irradiation with extraction (acetonitrile) (C). | | 2.640 ± 0.02 | 2.677 ± 0.02 | 2.697 ± 0.06 |
| | | | (11.62) | (10.38) | (9.71) |
| 4 | Irradiation with extraction (methanol) (D). | | 2.831 ± 0.01 | 2.696 ± 0.04 | 2.654 ± 0.06 |
| | | | (5.22) | (9.74) | (11.15) |
| 5 | Irradiation with oxidizer [H₂O₂ (10%)] (E). | | 2.592 ± 0.01 | 2.543 ± 0.04 | 2.548 ± 0.04 |
| | | | (13.22) | (14.86) | (14.70) |
| 6 | Irradiation with oxidizer [H₂O₂ (10%)] and extraction | | 2.305 ± 0.05 | 2.301 ± 0.05 | 2.232 ± 0.08 |
| | (salt solution) (F). | | (22.83) | (22.97) | (25.28) |
| 7 | Irradiation with oxidizer [H₂O₂ (10%)] and extraction | | 2.521 ± 0.02 | 2.524 ± 0.04 | 2.531 ± 0.03 |
| | (acetonitrile) (G). | | (15.60) | (15.51) | (15.27) |
| 8 | Irradiation with oxidizer [H₂O₂ (10%)] and extraction | | 2.273 ± 0.14 | 2.092 ± 0.05 | 2.067 ± 0.06 |
| | (methanol) (H). | | (23.9) | (29.96) | (30.80) |
| 9 | Irradiation with oxidizer [H₂O₂ (10%) + CH₃COOH | | 2.544 ± 0.14 | 2.527 ± 0.23 | 2.480 ± 0.03 |
| | (2%)] (I). | | (14.83) | (15.40) | (16.97) |
| 10 | Irradiation with oxidizer [H₂O₂ (10%) + CH₃COOH | | 2.114 ± 0.104 | 2.083 ± 0.006 | 1.957 ± 0.023 |
| | (2%)] and extraction (salt solution) (J). | | (29.23) | (30.26) | (34.48) |
| 11 | Irradiation with oxidizer [H₂O₂ (10%) + CH₃COOH | | 2.471 ± 0.06 | 2.31 ± 0.04 | 2.226 ± 0.04 |
| | (2%)] and extraction (acetonitrile) (K). | | (17.27) | (22.66) | (25.48) |
| 12 | Irradiation with oxidizer [H₂O₂ (10%) + CH₃COOH | | 2.532 ± 0.021 | 2.034 ± 0.04 | 1.913 ± 0.07 |
| | (2%)] and extraction (methanol) (L). | | (15.23) | (31.9) | (35.90) |

Values between brackets represent sulfur removal (%).
(*): Insignificant change in sulfur removal % (≦1.5%).

TABLE 2

| | | Absorbed dose (kGy) | | | |
|---|---|---|---|---|---|
| No. | Process | 0 | 50 | 100 | 200 |
| 1 | Irradiation only (A). | 1.408 ± 0.03 | 1.392 ± 0.01 | 1.390 ± 0.01 | 1.390 ± 0.01 |
| | | | (*) | (*) | (*) |
| 2 | Irradiation with extraction (salt solution) (B). | | 1.33 ± 0.08 | 1.254 ± 0.06 | 1.307 ± 0.02 |
| | | | (5.54) | (10.94) | (7.17) |
| 3 | Irradiation with extraction (acetonitrile) (C). | | 1.328 ± 0.02 | 1.268 ± 0.07 | 1.291 ± 0.05 |
| | | | (5.68) | (9.94) | (8.31) |
| 4 | Irradiation with extraction (methanol) (D). | | 1.328 ± 0.02 | 1.295 ± 0.02 | 1.218 ± 0.017 |
| | | | (5.68) | (8.03) | (13.49) |
| 5 | Irradiation with oxidizer [H₂O₂ (10%)] (E). | | 1.311 ± 0.05 | 1.264 ± 0.04 | 1.301 ± 0.04 |
| | | | (6.89) | (10.23) | (7.60) |
| 6 | Irradiation with oxidizer [H₂O₂ (10%)] and extraction | | 1.291 ± 0.01 | 1.25 ± 0.05 | 1.295 ± 0.02 |
| | (salt solution) (F). | | (8.31) | (11.22) | (8.03) |
| 7 | Irradiation with oxidizer [H₂O₂ (10%)] and extraction | | 1.288 ± 0.04 | 1.094 ± 0.01 | 0.988 ± 0.01 |
| | (acetonitrile) (G). | | (8.52) | (22.30) | (29.83) |
| 8 | Irradiation with oxidizer [H₂O₂ (10%)] and extraction | | 1.098 ± 0.01 | 0.951 ± 0.04 | 0.803 ± 0.02 |
| | (methanol) (H). | | (22.02) | (32.46) | (42.97) |
| 9 | Irradiation with oxidizer [H₂O₂ (10%) + CH₃COOH | | 1.268 ± 0.02 | 1.242 ± 0.07 | 1.213 ± 0.02 |
| | (2%)] (I). | | (9.94) | (11.79) | (13.85) |
| 10 | Irradiation with oxidizer [H₂O₂ (10%) + CH₃COOH | | 1.221 ± 0.02 | 1.135 ± 0.07 | 1.203 ± 0.01 |
| | (2%)] and extraction (salt solution) (J). | | (13.28) | (19.39) | (14.56) |
| 11 | Irradiation with oxidizer [H₂O₂ (10%) + CH₃COOH | | 1.145 ± 0.03 | 0.769 ± 0.01 | 0.522 ± 0.02 |
| | (2%)] and extraction (acetonitrile) (K). | | (18.68) | (45.38) | (62.93) |
| 12 | Irradiation with oxidizer [H₂O₂ (10%) + CH₃COOH | | 1.088 ± 0.012 | 0.516 ± 0.07 | 0.313 ± 0.01 |
| | (2%)] and extraction (methanol) (L). | | (22.73) | (63.35) | (77.77) |

Values between brackets represent sulfur removal (%).
(*): Insignificant change in sulfur removal % (≦1.5%).

On the other hand, the added AC to straight-run diesel with irradiation and extraction processes, a considerable improvement was observed in the removal of total sulfur upon irradiation at room temperature. As shown in Table 2, FIGS. 4 and 5, about 13.28, 19.39 and 14.56% (salt solution extraction); 18.68, 45.38 and 62.93% (acetonitrile extraction) and 22.73, 63.35 and 77.77% (methanol extraction) of total sulfur contents was removed from SRD with absorbed doses of 50, 100 and 200 kGy, respectively. Moreover, about 15.7, 42.3 and 54.6% on the average of total sulfur contents was removed from SRD with absorbed doses up to 200 kGy for the three investigated extraction processes, respectively. Therefore, oxidation of sulfur atom in liquid phase with gamma-irradiation (especially with 200 kGy) in the presence of AC and followed by extraction (especially with methanol) of oxidized species can lead to more desulfurization of SRD.

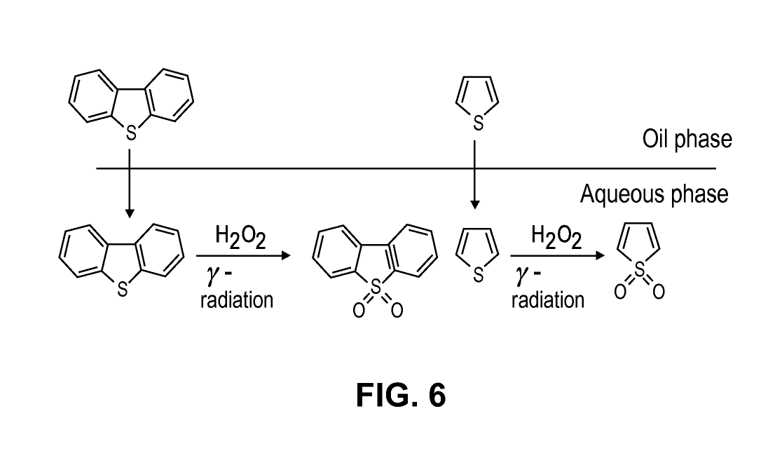

Because hydrogen peroxide can be dissolved in the aqueous phase, upon addition of hydrogen peroxide as an oxidant to water, the H₂O₂ was decomposed to hydroxyl radical in the system, and then was further decomposed to hydroperoxide radical (HOO⁻). This oxidizes the thiophene sulfides to the corresponding sulfone, and as the polarity of the sulfone was increased, sulfones remained in the aqueous phase. The process of this reaction is shown in FIG. 6.

In addition, the specification and drawings are to be regarded in an illustrative rather than as in a restrictive sense.

What is claimed is:

1. A method, comprising;
oxidizing a sulfur compound present in a crude oil and a diesel oil by adding at least one of an oxidizing agent, an extraction salt and a solvent to create a chemically active crude oil and the chemically active diesel for a desulphurization;
irradiating the chemically modified crude oil and chemically modified diesel oil using an absorbed dose of a specific type of radiation to make a clean crude oil and clean diesel; and
measuring a sulfur content for the clean crude oil and clean diesel to be used as a fuel with low emission.

2. The method of claim 1, further comprising;
adding the oxidizing agent and the solvent to the crude oil and diesel oil prior to the specific type of radiation for the desulphurization.

3. The method of claim 1, further comprising;
adding the oxidizing agent prior to the specific type of radiation, the solvent and the extraction salt to the crude oil and diesel oil after the specific type of radiation for the desulphurization.

4. The method of claim 1, further comprising;
adding the oxidizing agent prior to the specific type of radiation and the extraction salt to the crude oil and diesel oil after the specific type of radiation for the desulphurization.

5. The method of claim 1, wherein the absorbed dose is in the range of 50 kGy to 200 kGy.

6. The method of claim 5, wherein the absorbed dose is 50 kGy.

7. The method of claim 5, wherein the absorbed dose is 100 kGy.

8. The method of claim 5, wherein the absorbed dose is 200 kGy.

9. The method of claim 1, wherein the solvent is at least one of acetic acid, sodium chloride aqueous solution, acetone, acetonitrile, methanol, hexane, heptanes, toluene and petroleum ether.

10. The method of claim 1, wherein the oxidizer is H₂O₂.

11. A method, comprising;
modifying a sulfur compound present in a crude oil and a diesel oil by first adding an oxidizing agent and second adding a solvent to create a chemically active crude oil and the chemically active diesel for a desulphurization;
irradiating the chemically modified crude oil and chemically modified diesel oil using an absorbed dose of a specific type of radiation to make a clean crude oil and clean diesel; and
measuring a sulfur content for the clean crude oil and clean diesel to be used as a fuel with low emission.

12. The method of claim 11, wherein the specific absorbed dose is between 50-200 kGy.

13. The method of claim 11, wherein the solvent is at least one of a salt solution, acetonitrile and methanol.

14. The method of claim 11, wherein the oxidizer is H₂O₂

15. A method, comprising;
desulphurizing a crude oil and a diesel oil by modifying a sulfur compound present in the crude oil and the diesel oil by first adding an oxidizing agent and a first solvent and second adding a second solvent to create a chemically active crude oil and the chemically active diesel;
irradiating the chemically modified crude oil and chemically modified diesel oil using an absorbed dose of a specific type of radiation to make a clean crude oil and clean diesel; and
measuring a sulfur content for the clean crude oil and clean diesel to be used as a fuel with low emission.

16. The method of claim 15, wherein the specific absorbed dose is between 50-200 kGy.

17. The method of claim 16, wherein the specific absorbed dose is 200 kGy.

18. The method of claim 15, wherein the first solvent is acetic acid.

19. The method of claim 15, wherein the second solvent is at least one of a acetonitrile, methanol and salt solution.

20. The method of claim 15, wherein the oxidizer is H₂O₂.
